(19) United States
(12) Patent Application Publication
(10) Pub. No.: US 2008/0113072 A1
(43) Pub. Date: May 15, 2008

(54) Solid molasses products from liquid molasses

(76) Inventor: John H. Lee, Olathe, KS (US)

Correspondence Address: RIGEL TECHNOLOGY CORPORATION, 10677 WIDMER, LENEXA, KS, 66215, US

(21) Appl. No.: 11/598,126

(22) Filed: Nov. 13, 2006

(51) Int. Cl. A23L 1/09

(52) U.S. Cl. 426/471

(57) ABSTRACT

A novel processing method of producing a solid molasses product by a practical chemical processing method is provided. Liquid molasses is heated, mixed with calcium hydroxide at 2 to 25 percents (wt/wt) on a solid basis, dried to less than 15% moisture, and cooled to below 50 degree C. to convert the liquid molasses into the solid molasses in dry form. The solid molasses product is in block, particle or powder form. The oils with free fatty acid levels 20-80% (wt/vt) on a fat basis is added into liquid molasses and processed into molasses-fat block product with more hydrophobic function and water resistance. The process in this invention increases molasses content in the dried solid molasses from such as 42% to 90% and does not need dryer equipment, which increases the product value and reduces the related equipment and energy costs. The solid product in particle or powder form is free-flowing and easy to be handled, processed and delivered.

### FIELD OF THE INVENTION

The present invention relates to a novel processing method to convert liquid molasses into a solid product in dry form by a chemical processing method to improve product properties, reduce processing costs and be easy handling, further processing and delivering for more applications.

### BACKGROUND OF THE INVENTION

Molasses is a sugar liquid such as cane molasses, beet molasses, soy molasses, starch molasses, citrus molasses, hemicellulose extract and lactose molasses. After sugar processes, molasses has no crystallization capacity to form solid sugars by further crystallization. Cane molasses is from cane sugar process. Commercial cane molasses contains about 74% solids, 26% moisture, 48% sugars and 3% proteins. Beet molasses is from beet sugar process. Commercial beet molasses contains about 77% solids, 23% moisture, 48% sugars and 6% proteins. Soy molasses is from soybean protein process such as soy protein concentrate and isolate. Lactose molasses is from cheese, whey, and lactose processes. Citrus molasses is the partially dehydrated juices obtained from manufacture of dried citrus pulp. These carbohydrate molasses sugars are commonly concentrated into viscous liquids at solids of 65-80% in commercial molasses products.

Molasses is used in food, feed, biofuel (alcohol) and pharmaceutical industries. Molasses production has been increased significantly over years such as over 50% from 1976 to 1996 as a direct reflection of the increase in sugar production. The quantity of cane molasses produced was 33 mn tons in the world in 1996. The quantity of cane molasses produced was about 2 mn tons in the U.S. in 1996. Brazil, India, Thailand, China, USA, Pakistan, Mexico, Indonesia, Cuba, and Ukraine are the top ten countries for molasses production. It is estimated that 85% of cane molasses is used by the agricultural sector in Western Europe, who is the major importing area for molasses. Molasses has historically been used in feeds as a source of available carbohydrates (energy source) and sweeter for many species of animals.

Normally molasses is a viscous and sticky liquid. Cold molasses especially causes resistance to flow. The used pipelines, valves and fittings are larger than usually used for other liquids. In wintertime storage, molasses is kept warm in storage tanks. It costs more heat energy to keep warm before applications.

Molasses at high concentration is very hydrophilic, hygroscopic and sticky, which limits its properties and some applications. Liquid molasses is mixed with a carrier such as soybean hull at a high level such as 55% and dried and cooled down to form the current solid molasses product in a dried form at such as 45% molasses for nutritional applications. The dried molasses product from a major US manufacturer Westway Feed Products (New Orleans, La.) contains 42% molasses, which is produced by a drum dryer. The carriers such as soy hull have very high fibers and low nutritional values. Also the molasses in the product will melt into its liquid with absorbed moisture and heat process. Heat is often used in many processes. Drying the viscous and stick liquid molasses into a solid product is a difficult process. Fast spray drying and cooling processes may be used for the purpose. But the processing cost is very high. If liquid molasses can be solidified into a solid molasses product by a low-cost process such as a chemical process and the solid molasses product can handle a warm temperature such as 70 degree C., then the solid molasses products can be easily handled, processed and delivered for more applications at better price.

Over the years, various attempts have been made to convert molasses into solid products. U.S. Pat. No. 6,537,604 discloses a very simple processing method for an animal feed comprising a mixture of a liquid byproduct from agricultural processes selected from such as corn steep liquor, whey, molasses and a fibrous portion from milling such as soybean hulls. U.S. Pat. No. 6,368,657 discloses a method for converting liquid molasses into a non-sticky solid molasses-protein product with liquid animal blood proteins together under a heat treatment by the author. Animal blood proteins are used in the process, which may limit the product applications because animal protein source and animal diseases are concerned currently. U.S. Pat. No. 5,356,650 discloses a process for producing solid honey pouring the concentrated honey into containers and allowing the honey to cool and solidify to form a solid honey. The containers comprise a molding cavity having applied thereto a predetermined amount of palm oil effective to prevent adhesion of the concentrated pour honey to said molding cavity. U.S. Pat. No. 4,919,956 discloses a processing method for drying honey and molasses using extrusion or thin film drying. Then the hot dried molasses and honey are applied to a cold, rotating cylinder. Liquid molasses is often used to make molasses block products as self feed supplement applications for beefs and cows by U.S. Pat. Nos. 6,726,941, 6,440,478, 5,997,939, 5,622,739, 4,731,249 and 3,961,081. Dry nutrients such as protein meals, minerals and vitamins are mixed into the molasses block products with low moisture. But the molasses block products absorb moisture easily and become more soft and wet. U.S. Pat. No. 6,168,803 discloses to use alkaline earth metal oxide to improve the molasses block product. U.S. Pat. No. 6,143,333 discloses to use a phosphate source and magnesium oxide for fish attractant molasses block product. U.S. Pat. No. 4,731,249 discloses to use the polymer of polyvinyl alcohol for solidifying the molasses block product.

It has been found that calcium oxide can not be mixed well to form an uniform mass with liquid molasses. Animal blood proteins should be not used as possible to avoid people's concerns about animal proteins and diseases. It has been found calcium hydroxide at very wide range can be mixed with liquid molasses well to form an uniform mass and to solidify liquid molasses after reducing the moisture and cooling down at room temperature, which provides a new practical process to make liquid molasses into a solid product. There are no such related references and patents found, which are the same or close to this novel process in this invention.

### SUMMARY OF THE INVENTION

The present invention provides a practical chemical process to convert liquid molasses into a solid product in block, particle or powder form for reducing the processing costs and improving molasses properties and applications. The solid molasses products are easy handling, processing and delivering. The objective of the present invention is to provide the effective processing method, which is convenient and economical to be used.

Liquid molasses is heated into a low viscous liquid and calcium hydroxide in powder form at a rate of 2 to 25% (wt/wt) against liquid molasses on a solid basis is added and mixed to form a mixture mass. For the rate of 2 to 25%, the preferred range is 5 to 15%. Then the moisture is removed to a low level such as less than 15% by a heat or heat plus vacuum process. Heat is required to above 80 degree C. for reducing the moisture. A solid product is formed after cooling down to below 50 degree C. The solid product in block form can be further ground into particle or powder form.

It has been found that when calcium hydroxide is mixed with liquid molasses, calcium hydroxide and liquid molasses are easy to be mixed well to form an uniform mass. Calcium hydroxide is a common and cheap chemical, which can be such as food or feed grade. It has been also found that calcium oxide is not mixed well with liquid molasses because calcium oxide is not dissolved in molasses. Calcium oxide is still on the bottom of the molasses container or clamped together after a mixing and heat process. Calcium hydroxide is more hydrophilic than calcium oxide.

When calcium hydroxide in powder form at a rate of 2 to 25% (wt/wt) against normal liquid molasses with or without heat,. in which the moisture is not removed, on a solid basis is added into liquid and mixed to form a mixture mass. The mixture mass is very uniform just after the mixing. It is easy and takes short time such as few minutes to mix well for calcium hydroxide into the liquid molasses with normal moisture levels (20-35%). When molasses is heated or heated plus vacuumed into a low moisture level such as less than 10%, it takes longer time such as five to ten minutes more to mix calcium hydroxide and the liquid molasses into a mixture mass. Either adding calcium hydroxide before or after removing the moisture from liquid molasses can be used for making the solid molasses products. From the production and equipment convenience, it is more practical and operational to add calcium hydroxide after removing the moisture from liquid molasses. The value of pH can be adjusted by a base or acid such as sodium hydroxide or hydrogen chloride. After the moisture in molasses is removed by heat or heat plus vacuum, the viscosity of liquid molasses increases and there are less and less moisture bulbs during the heat process. Then calcium hydroxide is added into the liquid molasses, the viscosity of the mixture increases compared with the liquid molasses alone. There is still no difficulty for the agitation because the mixture is hot and viscosity is still low enough to be agitated or blended.

When the rate of calcium hydroxide against the solids of molasses is 10 against 100, the calcium hydroxide level in the solid molasses product is 9.1% on a solid basis (10/110). The calcium level in the solid molasses product is 4.9% on a solid basis (9.1%×40/(40+34)). The molasses level in the solid molasses product is 90.9% (100/110) on a solid basis. The calcium in calcium hydroxide may bind with molasses to form a complex product. The hydroxide in calcium hydroxide may be converted into moisture after binding with hydrogen from molasses. The added calcium or calcium hydroxide content in the formed solid molasses product is much lower than the normal dried solid molasses products with a carrier such as soy hull. The molasses level in the dried solid molasses product made by Westway Feed Products (New Orleans, La.) is only 42%. The dried solid molasses product produced by the company is widely used in feed industry, which is dried by drum dryer. The drum dryer is a major equipment cost plus more heat energy needed to operate the dryer. The solid molasses made by the novel process with 2-25% calcium hydroxide in this invention does not need a dryer, which reduces the processing costs significantly. The nutritional value of calcium is much better than fiber carriers such as soy hull. The molasses level in the new dried solid molasses product is increased from 42% to 90%.

When molasses is concentrated by a cooker or cooker plus vacuum to moisture 20-35% in sugar processing plants, the moisture in the molasses can be further removed to less than 15%. Then calcium hydroxide can be mixed into the liquid molasses. The solid molasses product is formed after cooling down to such as below 50 degree C. The processing costs can be reduced significantly compared with the current processes. Cooling can be done at room temperature for while or by a cooling equipment for fast cooling down. It has been found the solid molasses product can handle warm temperature and is still a solid form when the product temperature is heated to such as 80 degree C. Liquid molasses is always in liquid form and becomes less viscous when its temperature increases. The properties of solid molasses and liquid molasses are totally different. A sugar liquid such as viscous honey, corn syrup or liquid lactose can also be converted into a solid sugar product with the same process by the chemical process of calcium hydroxide in this invention. After the solidifying process for a sugar liquid, the added value may not be so significant as the solid molasses from a liquid molasses except changing the form from liquid into solid. The sale prices of solid sugars are higher than their molasses products.

Some liquid oils may be added into the molasses process. The purposes are to increase the energy level from the oils to meet the nutritional needs and to improve molasses products with better properties such as moisture-resistant molasses blocks for dairy cows. When a liquid oil with free fatty acids 20 to 80% on a fat solid basis is added into liquid molasses, the mixture can be converted into the solid products with calcium hydroxide at a rate of 2 to 25% (wt/wt) against the mixture of the liquid molasses and oils on a solid basis. The solid molasses-fat products are formed after removing the moisture and cooling down the mixture mass of the molasses, oil and calcium hydroxide. The liquid oils of soap stocks from vegetable oil or biodiesel process and the liquid fats from air flotation sludge process in waste water treatment are common low-grade fat ingredients with free fatty acids 20 to 80% on a fat solid basis. Their sale price is only about ⅓ compared with normal oil or fat products. The low-grade liquid oils of soap stocks from vegetable oil or biodiesel process and the liquid fats from air flotation sludge process can also be converted into non-oily solid fat products with the same processing method in this invention. Not only the properties of the oils and fats are improved, but also the values are increased such as more than double with this economical and convenient process. The solid product in particle or powder form is free-flowing and easy to be handled, processed, delivered and applied for applications. The solid product in block form is more water resistant and hard because the molasses block product contains calcium fatty acid salts, which are hard and not water soluble.

There are polar and non-polar groups in the molecules of air flotation sludge fats or vegetable soap stocks. The non-polar groups in the molecules bind each other with hydrophobic bond. The polar groups (—COOH) of free fatty acids in air flotation sludge fats or vegetable soap stocks are bound with calcium. When air flotation sludge fats or vegetable soap stocks are mixed with calcium hydroxide, the salt products of free fatty acids and calcium hydroxide are formed. The oily property of the liquid oils is converted into non-oily property of the solid fats because the formed salt products encapsulate non-polar groups of oils and change the oily property of the oils into non-oily products in solid form. So the process in this invention does not require the oils with natural free fatty acids 20 to 80% to be further hydrolyzed into glycerol and free fatty acids. The glycerol is removed by a separating process. One application of the free fatty acids is to convert the free fatty acids into non-oily calcium salts. Hydrolysis is an expensive process. It is more economical to use the oils with natural free fatty acids 20 to 80% and to encapsulate the partial oils with non-polar groups to form non-oily solid fat products. Fatty acid calcium salt products are not water soluble. The product value is increased significantly because the solid products have better properties and bypass function. The processing cost is reduced because the further hydrolysis process is not required.

The mixture product after adding calcium hydroxide into liquid molasses and oil with free fatty acids 20 to 80% and before cooling down may be mixed with other ingredients such as protein, minerals and vitamins together to form mixture products. Calcium hydroxide and other ingredients may be mixed together or separately and added into the molasses-fat mixture. Then a molasses-fat block product is formed after cooling down. The block product at a high fat level is not oily. It has bypass function and higher energy for dairy animals for more milk production. The molasses-fat block product improves the molasses block products by the hydrophobic and non-water soluble properties.

There are several benefits for the new solid molasses products such as (1) to increase the value and molasses level such as from 42% in current dried molasses by a drum dryer process to 90% in new solid molasses products by the new chemical process in this invention; (2) to save the processing costs for the drum dryer equipment and-heat energy; (3) to be easy handling, processing and delivering for more applications and (4) to improve the molasses block products into molasses-fat block products with the hydrophobic and non-water soluble properties.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

Liquid cane molasses (90 grams) was heated to boiling for 15 minutes. Calcium hydroxide in powder form (9 grams) was added and mixed to form a mixture mass. The liquid cane molasses had a solid level 78%. The rate of calcium hydroxide against cane molasses was 12.8% (9/(90×78%)) on a solid basis. The rate of calcium against cane molasses was 6.9% (12.8%×40/(40+34)) on a solid basis. The product was set at room temperature for two hours. Then the solid product was broken into particles. The particle product was non-stick and free-flowing.

### EXAMPLE 2

Liquid corn syrup (130 grams) was heated to boiling for 15 minutes. Calcium hydroxide in powder form (8 grams) was added and mixed to form a mixture mass. The liquid corn syrup had a solid level 75%. The rate of calcium hydroxide against corn syrup was 8.2% (8/(130×75%)) on a solid basis. The rate of calcium against cane molasses was 4.4% (8.2%×40/(40+34)) on a solid basis. The product was set at room temperature for two hours. Then the solid product was ground into powder form. The powder product was non-stick and free-flowing.

### EXAMPLE 3

Liquid beet molasses (80 grams) was mixed with calcium hydroxide in powder form (8 grams) to form a mixture mass. Then the mixture mass was mixed and heated to boiling for 20 minutes. The liquid beet molasses had a solid level 80%. The rate of calcium hydroxide against beet cane molasses was 12.5% (8/(80×80%)) on a solid basis. The rate of calcium against cane molasses was 6.8% (12.5%×40/(40+34)) on a solid basis. The product was set at room temperature for two hours. Then the solid product was ground into powder form. The powder product was non-stick and free-flowing.

### EXAMPLE 4

The liquid oil (100 grams) at 45 degree C. from a dissolved air flotation (DAF) unit in a chicken processing plant was heated to about 130 degree C. for 5 minutes. Calcium hydroxide (15 grams) was added and mixed to form a mixture mass. The rate of calcium hydroxide against the liquid oil was 15% (15/100) on a solid basis. The rate of calcium against the liquid oil was 8.1% (15%×40/(40+34)) on a solid basis. The liquid oil had free fatty acid level 50% on a fat solid basis. The product was set at room temperature for two hours. Then the solid product was ground into fine particles. The particle product was non-oily and free-flowing. The product had the bypass fat (93.4%) on a fat basis by the incubation in ruminant fluid for 24 hours.

### EXAMPLE 5

Liquid beet molasses (150 grams) was mixed with soy soap stock oil (120 grams) and heated to boiling for 25 minutes. Then calcium hydroxide in powder form (22.5 grams) was mixed to form a mixture mass. The liquid beet molasses had a solid level 80%. The soy soap stock oil had a solid level 99.5% and a free fatty acid level 45% on a fat solid basis. The rate of the soy soap stock oil against the beet cane molasses was 1 (120×99.5%/(150×80%)) on a solid basis. The rate of calcium hydroxide against the mixture of the beet cane molasses and soy soap stock oil was 9.4% (22.5/(120×99.5%+150×80%)) on a solid basis. The rate of calcium against the mixture of the beet cane molasses and soy soap stock oil 5.1% (9.4%×40/(40+34)) on a solid basis. Half of the product was set at room temperature for two hours. Then the solid product was ground into powder form. The powder product was non-oily and free-flowing. The soy soap stock oil level in the beet cane molasses, soy soap stock oil and calcium hydroxide was 45.7% (120×99.5%/(150×80%+120×99.5%+22.5)). Another half of the product was mixed with soy protein meal (50 grams), poured into a metal container and set at room temperature for two hours to form a hard block form. The block was not oily. Also calcium hydroxide was not used in a control process. Then the product from the control process was very oily. There was the oil on the product.

What is claimed is:

1. A method of preparing a solid molasses product from liquid molasses comprising heating the liquid molasses, adding calcium hydroxide at 2 to 25 percents (wt/wt) on a solid basis, drying to less than 15% moisture, and cooling to below 50 degree C. to convert the liquid molasses into the solid molasses in dry form.

2. The method of claim 1 wherein the liquid molasses is from plant or animal sources.

3. The method of claim 1 wherein the liquid molasses is a sugar liquid.

4. The method of claim 1 wherein an oil with free fatty acid level 20-80% (wt/wt) on a fat basis is added into or replace the liquid molasses.

5. The method of claim 1 wherein the dying process is by a heat or heat plus vacuum process to remove the moisture to less than 15% moisture in the product.

6. The method of claim 1 wherein an ingredient is added in the process.

7. The method of claim 1 wherein the product is in block, particle or powder form.

8. The method of claim 1 wherein a sugar liquid is processed by the same method.

9. The method of claim 1 wherein the product is made.
